(19) United States
(12) Patent Application Publication
(10) Pub. No.: US 2025/0209311 A1
(43) Pub. Date: Jun. 26, 2025

(54) DYNAMIC CONTENT GENERATION

(71) Applicant: Capital One Services, LLC, McLean, VA (US)

(72) Inventors: Bryan TAMAYO, Allen, TX (US); Michelle REID, Prosper, TX (US)

(21) Appl. No.: 18/392,287

(22) Filed: Dec. 21, 2023

(51) Int. Cl. G06N 3/0475; G06N 3/0455; H04L 67/306; H04L 67/5682

(52) U.S. Cl. CPC G06N 3/0475; G06N 3/0455; H04L 67/306; H04L 67/5682

(57) ABSTRACT

In some implementations, a system may detect a creation of content. The system may transmit a request to a generative system in response to detection of the creation of the content. The request may include the content, and may cause the generative system to generate a plurality of alternate versions of the content, where the plurality of alternate versions are in different content styles. The system may receive, from the generative system, a response that includes the plurality of alternate versions. The system may cache the plurality of alternate versions in a content delivery network using edge caching. The system may receive, from a user device of a user, an access request for a content document. The system may select, in response to the access request, an alternate version in accordance with the user's user profile. The system may transmit the content document with the alternate version included therein.

### BACKGROUND

A content delivery network (CDN) is a geographically distributed network of proxy servers and data centers, distributing service spatially relative to end-users in order to provide high availability and high performance. A CDN can facilitate a variety of different types of content delivery services including video streaming, software downloads, and web and mobile content delivery. A CDN can serve a number of different types of content, including web objects (e.g., text, graphics, and/or scripts), downloadable objects (e.g., media files, software, and/or documents), applications (e.g., e-commerce applications and/or portals), live streaming media, on-demand streaming media, and/or social networks.

### SUMMARY

Some implementations described herein relate to a system for dynamic content generation. The system may include one or more memories and one or more processors communicatively coupled to the one or more memories. The one or more processors may be configured to detect a creation of content that is to be published to a content document. The one or more processors may be configured to transmit a request to a generative system in response to detection of the creation of the content, where the request includes the content, where the request is to cause the generative system to generate a plurality of alternate versions of the content using artificial intelligence, and where the plurality of alternate versions of the content are in different content styles. The one or more processors may be configured to receive, from the generative system, a response that includes the plurality of alternate versions of the content. The one or more processors may be configured to cache the plurality of alternate versions of the content in a content delivery network using edge caching. The one or more processors may be configured to receive, from a user device of a user, an access request for the content document. The one or more processors may be configured to select, in response to the access request, an alternate version of the plurality of alternate versions in accordance with a user profile of the user. The one or more processors may be configured to transmit the content document with the alternate version included in the content document.

Some implementations described herein relate to a method of dynamic content generation. The method may include detecting a creation of content that is to be published to a content document. The method may include transmitting a request to a generative system in response to detection of the creation of the content, where the request includes the content, where the request is to cause the generative system to generate a plurality of alternate versions of the content, and where the plurality of alternate versions of the content are in different content styles. The method may include receiving, from a user device of a user, an access request for the content document. The method may include transmitting, for the user device, the content document with the content included in the content document. The method may include selecting an alternate version, of the plurality of alternate versions, in accordance with a user profile of the user. The method may include causing adjustment of the content document to replace the content with the alternate version.

Some implementations described herein relate to a non-transitory computer-readable medium that stores a set of instructions for dynamic content generation. The set of instructions, when executed by one or more processors of a device, may cause the device to transmit, to a generative system, a request that includes content that is to be published to a content document, where the request is to cause the generative system to generate, using artificial intelligence, a plurality of alternate versions of the content, and where the plurality of alternate versions of the content are in different content styles. The set of instructions, when executed by one or more processors of the device, may cause the device to receive, from a user device of a user, an access request for the content document. The set of instructions, when executed by one or more processors of the device, may cause the device to select, in response to the access request and for inclusion in the content document, an alternate version of the plurality of alternate versions in accordance with a preferred content style of the user.

### BRIEF DESCRIPTION OF THE DRAWINGS

FIGS. 1A-1D are diagrams of an example associated with dynamic content generation, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with dynamic content generation, in accordance with some embodiments of the present disclosure.

FIG. 4 is a flowchart of an example process associated with dynamic content generation, in accordance with some embodiments of the present disclosure.

### DETAILED DESCRIPTION

The following detailed description of example implementations refers to the accompanying drawings. The same reference numbers in different drawings may identify the same or similar elements.

An electronic document, such as a web page, may contain content that is presented to a user that accesses the electronic document. Generally, the content is static, such that each user that accesses the electronic document is presented the same content. Static content is less likely to engage users than personalized, dynamic content. However, an electronic document containing dynamic content may exhibit performance issues. For example, techniques such as in-page content modification and/or client-side processing that are used to generate dynamic content for an electronic document can lead to slow performance and longer loading times.

Some implementations described herein enable dynamic content generation for an electronic document. In particular, implementations described herein enable personalized, dynamic content to be used in electronic documents with improved performance and faster loading times. In some implementations, a system may monitor for the creation of new content that is to be published to an electronic document. When the content is detected, the system may cause alternate versions of the content to be generated (e.g., using artificial intelligence (AI)). Each of the alternate versions may employ a different content style. By generating the alternate versions in advance in response to the creation of the content, rather than waiting until the content is requested, lag that may otherwise occur due to on-demand processing can be reduced. The generated alternate versions may be cached in a content delivery network (CDN) using edge caching. In response to a request for the electronic document made by a user, the system may select one of the alternate versions that employs a content style preferred by the user. In this way, the electronic document may contain personalized, dynamic content for the user. Moreover, by caching the alternate versions, the dynamic content can be provided with improved performance and faster loading times.

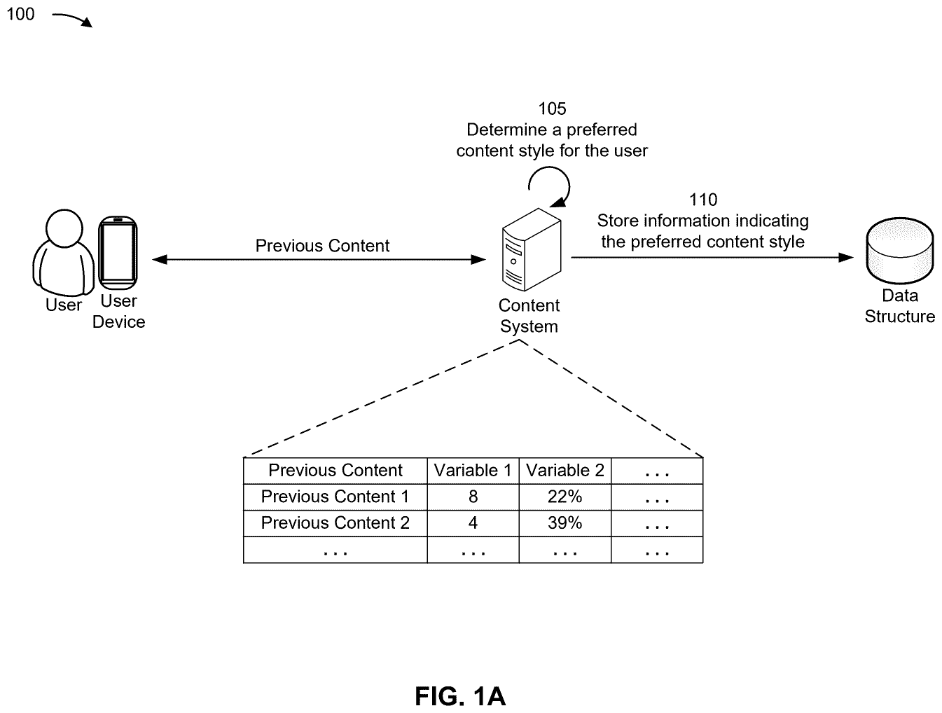

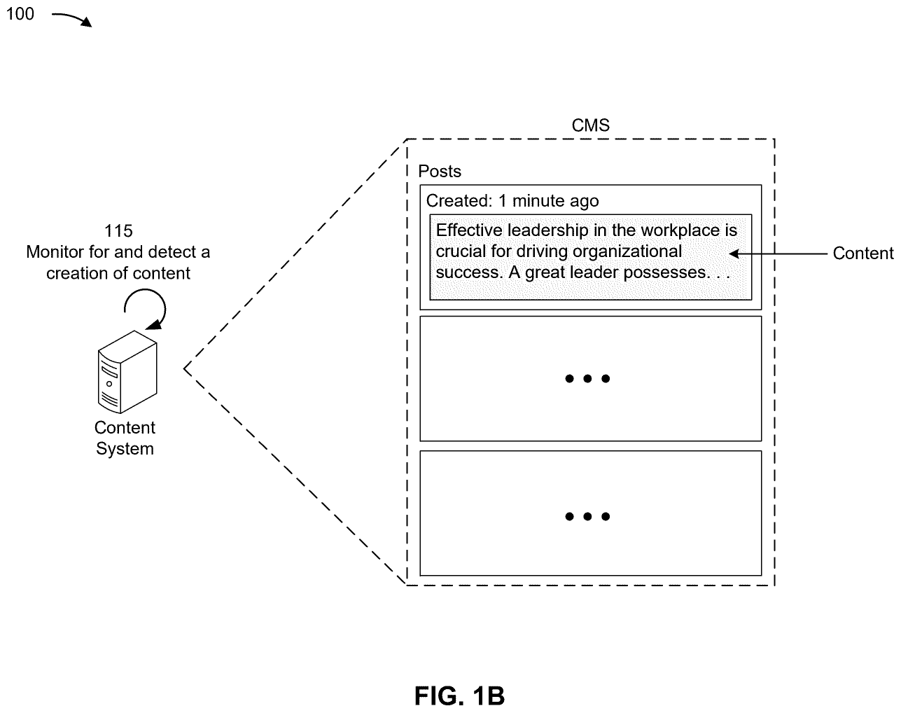

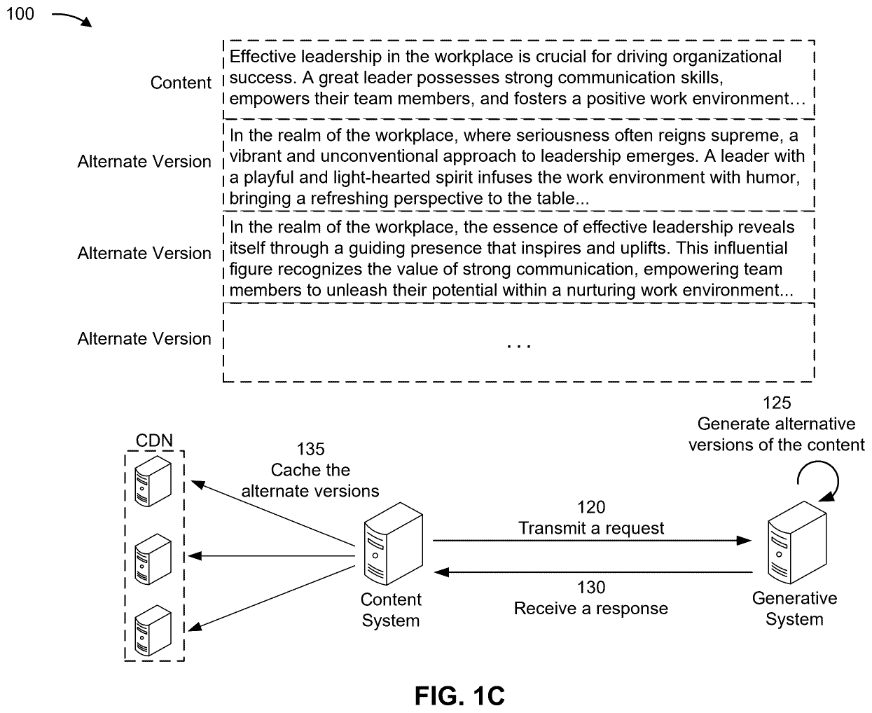

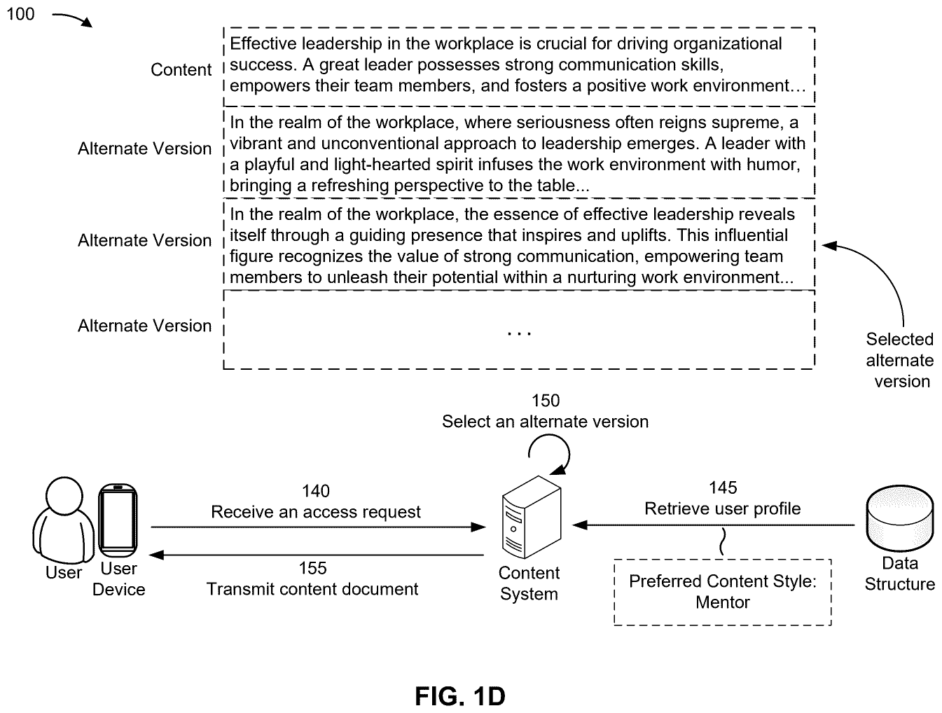

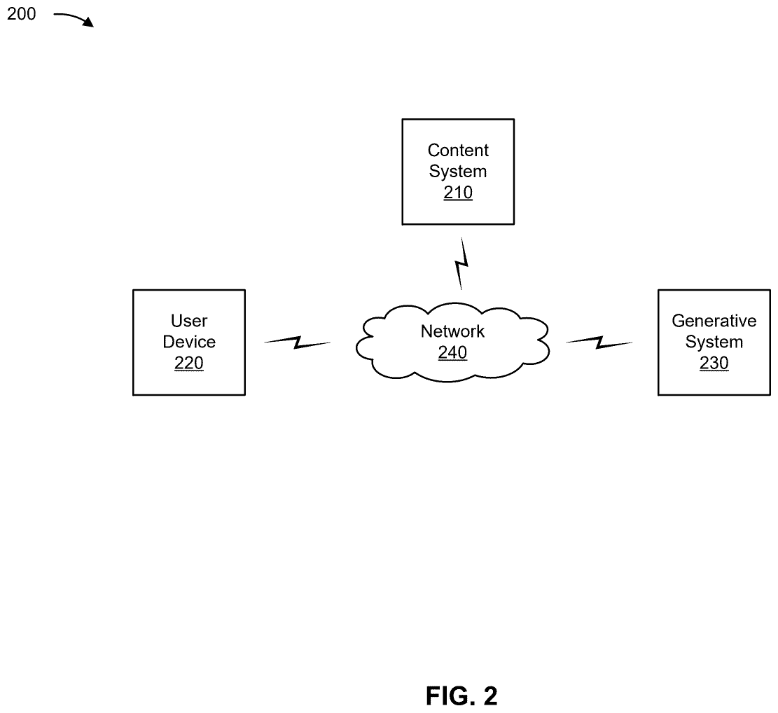

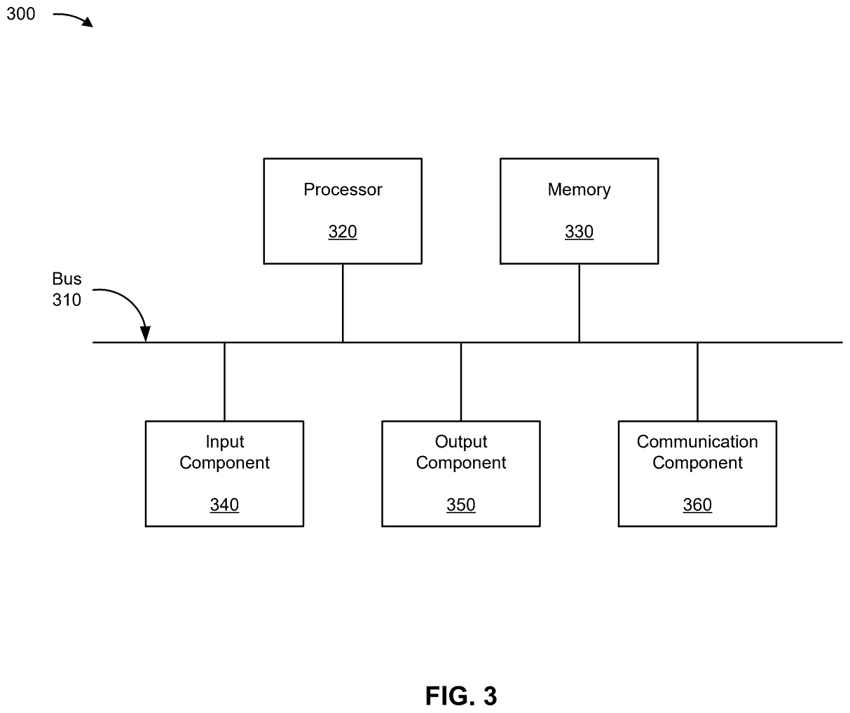

FIGS. 1A-1D are diagrams of an example 100 associated with dynamic content generation. As shown in FIGS. 1A-1D, example 100 includes a content system, a user device, and a generative system. These devices are described in more detail in connection with FIGS. 2 and 3.

The content system may be associated with an entity that provides content via a network, such as the Internet. For example, the content system may be used to deliver content documents, such as one or more web pages, a website, mobile application content, or the like. In some implementations, the content system may include, or may be included in, a content delivery network (CDN) that includes multiple, geographically distributed servers. In some implementations, the content system may include, or may be included in, a content management system (CMS) (e.g., that is a part of the CDN) configured to control the creation and publication of content, such as news articles, blog posts, images, videos, or the like. The user device may be associated with a user that is a consumer of content.

The generative system and the content system may be separate (e.g., may not share computing resources). For example, the generative system may be located off-site relative to the content system. The generative system may be configured to generate content. For example, the generative system may generate content using artificial intelligence (AI) (e.g., the generative system is a generative AI system). In some implementations, the generative system may be configured to generate text content. For example, the generative system may generate text content using an AI language model, such as a natural language processing (NLP) model, an artificial neural network model, a large language model (LLM), and/or a generative pre-trained transformer (GPT) model, among other examples. Additionally or alternatively to text content, the generative system may be configured to generate image content, audio content, and/or video content.

As shown in FIG. 1A, and by reference number 105, the content system may determine a preferred content style for the user. In some implementations, the preferred content style for the user may be a preference or setting indicated for the user (e.g., via an indication transmitted from the user device and received by the content system). Alternatively, the content system may determine the preferred content style for the user based on data associated with the user. For example, the data may include demographic data associated with the user (e.g., indicating the user's age, the user's residence location, the user's occupation, or the like). As another example, the data may include interaction data indicating variables relating to the user's historical interactions with previous content provided by the content system. For example, the interaction data may indicate a viewing (e.g., browsing) history associated with the user, amounts of time that the user spent viewing particular content, scrolling activity of the user when viewing particular content (e.g., a scroll depth, a scrolling speed, and/or a scrolling direction), and/or a clicking activity of the user when viewing particular content (e.g., indicating on what, where, and/or how often the user clicked, tapped, or selected content), among other examples. In some implementations, the content system may determine the preferred content style for the user using a machine learning model trained to output the preferred content style in response to an input of the data associated with the user.

A content style may correspond to a content archetype (e.g., a persona that dictates the style in which content is to be generated). Example content archetypes include a Hero archetype (e.g., dictating a heroic style intended to inspire with tales of overcoming obstacles), a Jester archetype (e.g., dictating a humorous and lighthearted style intended to entertain with witty anecdotes, funny stories, and/or playful observations), a Warrior archetype (e.g., dictating a bold and assertive style intended to tackle tough issues, advocate for justice, and inspire readers to stand up for their beliefs), or a Mentor archetype (e.g., dictating a mentoring style intended to provide guidance, share experiences, and offer practical advice on personal and professional growth), among other examples. As shown by reference number 110, the content system may store information, in a data structure (e.g., a database), indicating the preferred content style for the user in association with a user identifier of the user. In some implementations, the content system may cause the setting of a cookie or a session variable that indicates the preferred content style for the user.

As shown in FIG. 1B, and by reference number 115, the content system may monitor for and detect a creation of content. For example, the content system may detect that a new piece of content has been created in the CMS. The content may have been created by a person (e.g., the content may be authored content). In some implementations, to detect the creation of the content, the content system may monitor a data structure (e.g., a database), used to store content, for new entries. Additionally, or alternatively, to detect the creation of the content, the content system may receive or retrieve a message that indicates the creation of the content (e.g., from an event stream). The content may be intended for publication to a content document, such as a web page. The content may include text content (e.g., a news article or a blog post), image content, audio content, and/or video content.

As shown in FIG. 1C, and by reference number 120, in response to detecting the creation of the content, the content system may transmit a request to the generative system. The request may include the content (e.g., include the content itself or include a link or other pointer to the content). In some implementations, the request may indicate respective user profiles for a plurality of users (e.g., that are consumers of content of the content system). For example, each user profile for a user may indicate a user identifier and a preferred content style of the user. In some implementations, the content system may scan the user profiles for the plurality of users to identify which distinct content styles are preferred among the users, and the request may indicate only the distinct content styles (e.g., by removing duplicates) preferred among the users.

As shown by reference number 125, the request may cause the generative system to generate a plurality of alternate versions of the content. The alternate versions of the content may be the same type as the content (e.g., text content) and may express the same idea as the content, but may differ in composition (e.g., word choice, format, layout, or the like) from the content. To generate the alternate versions, the generative system may use one or more algorithms and/or one or more templates to dynamically modify the content according to the content styles indicated by the request. For example, the generative system may generate the alternate versions of the content using AI.

For example, to generate the alternate versions, the generative system may input the content into the AI language model. Moreover, the generative system may input a prompt for the AI language model indicating the content styles that are to be used to generate the alternate versions. The AI language model may be configured to analyze the structure, tone, and/or language patterns of the content and to transform the content (e.g., based on the analysis) to align with the indicated content style.

Accordingly, the alternate versions may have different content styles from each other (e.g., different content styles corresponding to the preferred content styles indicated by the user profiles). For example, the composition of each alternate version may be different from the composition of any other alternate version due to the use of the different content styles. In this way, the alternate versions convey the same information as the content, but are in different content styles that appeal to different users (e.g., different consumers of the content). By generating the alternate versions in advance in response to the creation of the content, rather than waiting until the content is requested, the content system can reduce lag that may otherwise occur due to on-demand processing.

In some implementations, the generative system may generate an alternate version of the content that is user-specific. For example, in addition to the user's preferred content style, the user-specific alternate version of the content may also be based on user-specific data, such as survey data and/or behavioral data (e.g., the interaction data) associated with the user. As an example, the user-specific data may indicate user-specific variables, such as interests of the user, current events associated with the user, and/or aversions of the user, among other examples. For example, survey data may indicate a particular problem that is experienced by the user. Accordingly, the user-specific alternate version may mention, address, or focus on the user-specific variables. For example, the user-specific alternate version may address the particular problem that is experienced by the user. In some implementations, the generative system may generate the user-specific alternate version by additionally inputting the user-specific data into the AI language model.

In some implementations, the generative system may store the alternate versions in a data structure (e.g., a database). For example, an alternate version based on a particular content style may be stored in association with one or more user identifiers of the users having a preference for that content style (e.g., as indicated by the user profiles). In some implementations, as shown by reference number 130, the content system may receive, from the generative system, a response (to the request) that includes the alternate versions of the content. In some implementations, as shown by reference number 135, the content system may cache the alternate versions of the content. For example, the content system may cache the alternate versions in the CDN using edge caching (e.g., caching of the alternate versions in several geographically-distributed servers closer to the CDN's edge, rather than in a central storage location). Thus, the content system may generate one or more sets of copies of the alternate versions, and each set of copies may be cached in a respective geographically-distributed server of the CDN. By caching the alternate versions of the content, the content system can provide dynamic content for an individual user with reduced lag and load time.

As shown in FIG. 1D, and by reference number 140, the content system may receive, from the user device, an access request (e.g., a hypertext transfer protocol (HTTP) request) for the content document (e.g., a web page). For example, the user device may request access to a web page that is served by the content system. In some implementations, the access request may indicate a user identifier associated with the user. For example, session information associated with the user may include a variable indicating the user identifier. In some implementations, the access request may indicate a geographic location associated with the user device (e.g., based on an Internet Protocol (IP) address associated with the user device). In some implementations, a service layer (e.g., a web service layer), interfacing with the CDN via an application programming interface (API), may be configured to handle access requests made by user devices.

As shown by reference number 145, the content system may retrieve the user's user profile from the data structure using the user identifier associated with the user. As described herein, the user profile may indicate a preferred content style of the user. In some implementations, the content system may retrieve the user's preferred content style from a cookie or a session variable set by the content system.

As shown by reference number 150, in response to the access request, the content system may select an alternate version, from the plurality of alternate versions, for inclusion in the content document. For example, the content system may select the alternate version in accordance with the user profile. As an example, the content system may select an alternate version that uses the user's preferred content style. In some implementations, the content system may select an alternate version associated with a default content style if the user's preferred content style is unknown (e.g., the user is a new user or the user is not logged in).

In some implementations, to select the alternate version, the content system may retrieve the alternate version from the cache. For example, a copy of the alternate version may be retrieved from a server of the CDN that is geographically located nearest to the geographical location of the user device. In some implementations, to select the alternate version, the content system may transmit a content request for the alternate version to the generative system, and receive the alternate version from the generative system in response to the content request. For example, the content request may indicate the user identifier of the user to enable the generative system to retrieve the alternate version from a data structure using an association between the alternate version and the user identifier.

As shown by reference number 155, the content system may transmit the content document to the user device. In some implementations, the content document transmitted to the user device may include the alternate version of the content (e.g., the content system may render the content document to include the alternate version of the content). In some implementations, a baseline version of the content document may include the content. In some implementations, the content system may adjust the baseline version of the content document to replace the content with the alternate version of the content. In some implementations, the content document transmitted to the user device may be the baseline version of the content document, and the content system may cause adjustment of the baseline version of the content document to replace the content with the alternate version of the content. For example, the baseline version of the content document may include code configured to trigger an asynchronous request for the alternate version of the content from the content system, and the content system may transmit the alternate version of the content to cause the code to replace the content with the alternate version of the content (e.g., by modifying a document object model for the content document). In some implementations, the service layer may retrieve the alternate version of the content, via the API, and may cause adjustment of the baseline version of the content document to replace the content with the alternate version of the content. In some implementations, a cached copy of the alternate version may be transmitted to the user device from a server of the CDN that is geographically located nearest to the geographical location of the user device.

In some implementations, the content system may monitor for and detect (e.g., using a scheduled task and/or a webhook) an update to the content, in a similar manner as described above. For example, the content system may detect that the content has been updated in the CMS. In response to detecting the update to the content, the content system may transmit an additional request to the generative system to cause the generative system to generate updated alternate versions of the content, in a similar manner as described above. The generative system may store the updated alternate versions of the content in the data structure (e.g., replacing the previous alternate versions) and/or the content system may receive and cache the updated alternate versions of the content, in a similar manner as described above.

In some implementations, the content system may collect data (e.g., user-specific data) for influencing the AI model of the generative system. The data may include survey data produced by the user and/or behavioral data relating to the user (e.g., the interaction data described above). The content system may transmit the data to the generative system to facilitate training, re-training, and/or adjustment (e.g., hyperparameter adjustment) of the AI model. In some implementations, the content system may collect data relating to content styles used for content. For example, the data may indicate performance metrics (e.g., indicating popularity, user engagement, bounce rates, or the like) relating to the content styles. In some implementations, the content system may determine one or more default content styles using a machine learning model trained to output a default content style based on an input of the data. As described herein, the default content style may be used to select a version of content for a user for which a preferred content style is unknown.

In some implementations, the content system may receive, from the user device, a subsequent access request for the content document. During a time period between the access request and the subsequent access request, the user's preferred content style may have changed. For example, the user's preferred content style may have changed due to updates to the interaction data associated with the user (e.g., due to subsequent interactions by the user with content provided by the content system). In accordance with the user's changed preferred content style, the content system may select a different alternate version of the content (e.g., different from the alternate version previously selected) for inclusion in the content document. In this way, the version of the content included in the content document may change each time the user requests access to the content document.

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a content system 210, a user device 220, a generative system 230, and a network 240. Devices of environment 200 may interconnect via wired connections, wireless connections, or a combination of wired and wireless connections.

The content system 210 may include one or more devices capable of receiving, generating, storing, processing, providing, and/or routing information associated with dynamic content generation, as described elsewhere herein. The content system 210 may include a communication device and/or a computing device. For example, the content system 210 may include a server, such as an application server, a client server, a web server, a database server, a host server, a proxy server, a virtual server (e.g., executing on computing hardware), or a server in a cloud computing system. In some implementations, the content system 210 may include computing hardware used in a cloud computing environment.

The user device 220 may include one or more devices capable of receiving, generating, storing, processing, and/or providing information associated with dynamic content generation, as described elsewhere herein. The user device 220 may include a communication device and/or a computing device. For example, the user device 220 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The generative system 230 may include one or more devices capable of receiving, generating, storing, processing, providing, and/or routing information associated with dynamic content generation, as described elsewhere herein. The generative system 230 may include a communication device and/or a computing device. For example, the generative system 230 may include a server, such as an application server, a client server, a web server, a database server, a host server, a proxy server, a virtual server (e.g., executing on computing hardware), or a server in a cloud computing system. In some implementations, the generative system 230 may include computing hardware used in a cloud computing environment.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with dynamic content generation. The device 300 may correspond to content system 210, user device 220, and/or generative system 230. In some implementations, content system 210, user device 220, and/or generative system 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

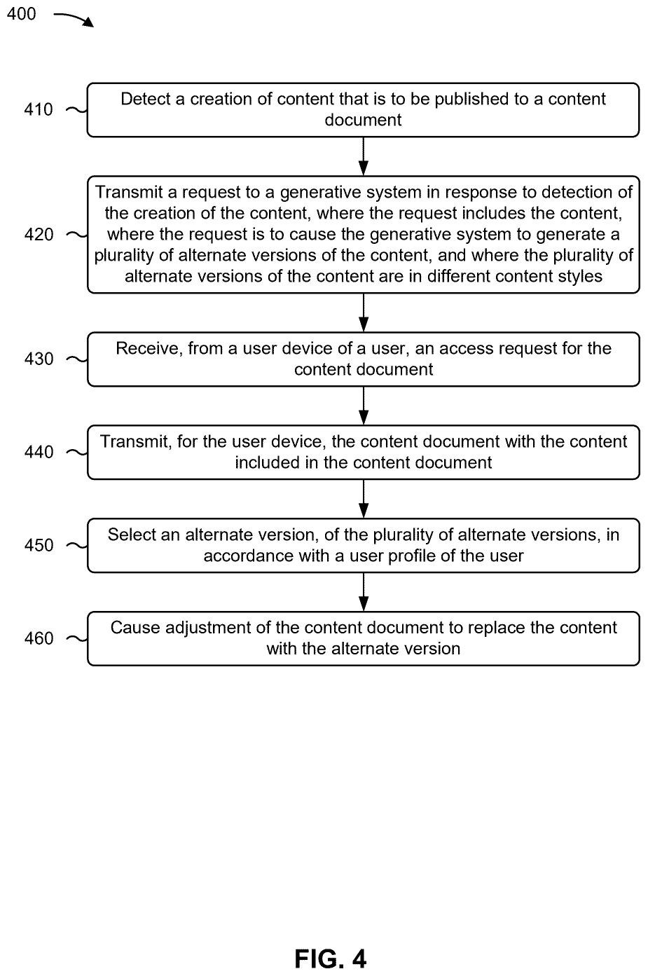

FIG. 4 is a flowchart of an example process 400 associated with dynamic content generation. In some implementations, one or more process blocks of FIG. 4 may be performed by the content system 210. In some implementations, one or more process blocks of FIG. 4 may be performed by another device or a group of devices separate from or including the content system 210, such as the user device 220 and/or the generative system 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include detecting a creation of content that is to be published to a content document (block 410). For example, the content system 210 (e.g., using processor 320, memory 330, and/or communication component 360) may detect a creation of content that is to be published to a content document, as described above in connection with reference number 115 of FIG. 1B. As an example, a new piece of content (e.g., a blog post) that has been created in a CMS may be detected.

As further shown in FIG. 4, process 400 may include transmitting a request to a generative system in response to detection of the creation of the content, where the request includes the content, where the request is to cause the generative system to generate a plurality of alternate versions of the content, and where the plurality of alternate versions of the content are in different content styles (block 420). For example, the content system 210 (e.g., using processor 320, memory 330, and/or communication component 360) may transmit a request to a generative system in response to detection of the creation of the content, as described above in connection with reference number 120 of FIG. 1C. As an example, the alternate versions of the content may be the same type as the content (e.g., text content) and may express the same idea as the content, but may differ in composition from the content.

As further shown in FIG. 4, process 400 may include receiving, from a user device of a user, an access request for the content document (block 430). For example, the content system 210 (e.g., using processor 320, memory 330, and/or communication component 360) may receive, from a user device of a user, an access request for the content document, as described above in connection with reference number 140 of FIG. 1D. As an example, the user device may request access to a web page.

As further shown in FIG. 4, process 400 may include transmitting, for the user device, the content document with the content included in the content document (block 440). For example, the content system 210 (e.g., using processor 320, memory 330, and/or communication component 360) may transmit, for the user device, the content document with the content included in the content document, as described above in connection with reference number 155 of FIG. 1D. As an example, a baseline version of the content document that includes the original content may be transmitted to the user device.

As further shown in FIG. 4, process 400 may include selecting an alternate version, of the plurality of alternate versions, in accordance with a user profile of the user (block 450). For example, the content system 210 (e.g., using processor 320 and/or memory 330) may select an alternate version, of the plurality of alternate versions, in accordance with a user profile of the user, as described above in connection with reference number 150 of FIG. 1D. As an example, an alternate version that uses the user's preferred content style may be selected.

As further shown in FIG. 4, process 400 may include causing adjustment of the content document to replace the content with the alternate version (block 460). For example, the content system 210 (e.g., using processor 320, memory 330, and/or communication component 360) may cause adjustment of the content document to replace the content with the alternate version, as described above in connection with reference number 155 of FIG. 1D. As an example, the baseline version of the content document may include code configured to trigger an asynchronous request for the alternate version of the content, and the alternate version of the content may be transmitted to cause the code to replace the content with the alternate version of the content.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for dynamic content generation, the system comprising:
one or more memories; and
one or more processors, communicatively coupled to the one or more memories, configured to:
detect a creation of content that is to be published to a content document;
transmit a request to a generative system in response to detection of the creation of the content,
wherein the request includes the content,
wherein the request is to cause the generative system to generate a plurality of alternate versions of the content using artificial intelligence (AI), and
wherein the plurality of alternate versions of the content are in different content styles;
receive, from the generative system, a response that includes the plurality of alternate versions of the content;
cache the plurality of alternate versions of the content in a content delivery network using edge caching;
receive, from a user device of a user, an access request for the content document;
select, in response to the access request, an alternate version of the plurality of alternate versions in accordance with a user profile of the user; and
transmit the content document with the alternate version included in the content document.

2. The system of claim 1, wherein the access request indicates a user identifier of the user, and
wherein the one or more processors are further configured to:
retrieve the user profile from a data structure in accordance with the user identifier.

3. The system of claim 1, wherein the user profile indicates a preferred content style of the user.

4. The system of claim 1, wherein the one or more processors are further configured to:
determine a preferred content style of the user in accordance with data relating to historical interactions of the user with previous content.

5. The system of claim 1, wherein the request indicates respective user profiles for a plurality of users that includes the user, and
wherein the different content styles correspond to respective preferred content styles indicated by the respective user profiles.

6. The system of claim 1, wherein the one or more processors are further configured to:
detect an update to the content; and
transmit an additional request to the generative system in response to detection of the update to the content,
wherein the additional request is to cause the generative system to generate a plurality of updated alternate versions of the content using AI.

7. The system of claim 1, wherein the content is a text content.

8. A method of dynamic content generation, comprising:
detecting a creation of content that is to be published to a content document;
transmitting a request to a generative system in response to detection of the creation of the content,
wherein the request includes the content,
wherein the request is to cause the generative system to generate a plurality of alternate versions of the content, and
wherein the plurality of alternate versions of the content are in different content styles;
receiving, from a user device of a user, an access request for the content document;
transmitting, for the user device, the content document with the content included in the content document;
selecting an alternate version, of the plurality of alternate versions, in accordance with a user profile of the user; and
causing adjustment of the content document to replace the content with the alternate version.

9. The method of claim 8, further comprising:
receiving, from the generative system, a response that includes the plurality of alternate versions of the content; and
caching the one or more alternate versions of the content.

10. The method of claim 9, wherein caching the one or more alternate versions of the content, comprises:
caching the one or more alternate versions of the content in a content delivery network using edge caching.

11. The method of claim 8, wherein causing adjustment of the content document comprises:
receiving an asynchronous request triggered by code in the content document; and
transmitting the alternate version to cause replacement of the content with the alternate version in the content document.

12. The method of claim 8, wherein the user profile indicates a preferred content style of the user.

13. The method of claim 8, wherein the request is to cause the generative system to generate the plurality of alternate versions of the content using artificial intelligence.

14. A non-transitory computer-readable medium storing a set of instructions for dynamic content generation, the set of instructions comprising:
one or more instructions that, when executed by one or more processors of a device, cause the device to:
transmit, to a generative system, a request that includes content that is to be published to a content document,
wherein the request is to cause the generative system to generate, using artificial intelligence, a plurality of alternate versions of the content, and
wherein the plurality of alternate versions of the content are in different content styles;
receive, from a user device of a user, an access request for the content document; and
select, in response to the access request and for inclusion in the content document, an alternate version of the plurality of alternate versions in accordance with a preferred content style of the user.

15. The non-transitory computer-readable medium of claim 14, wherein the one or more instructions, when executed by the one or more processors, further cause the device to:
transmit the alternate version for inclusion in the content document.

16. The non-transitory computer-readable medium of claim 14, wherein the access request indicates an identifier associated with the user.

17. The non-transitory computer-readable medium of claim 14, wherein the one or more instructions, when executed by the one or more processors, further cause the device to:
receive, from the generative system, a response that includes the plurality of alternate versions of the content; and
cache the one or more alternate versions of the content.

18. The non-transitory computer-readable medium of claim 17, wherein the one or more instructions, that cause the device to cache the one or more alternate versions of the content, cause the device to:
cache the one or more alternate versions of the content in a content delivery network using edge caching.

19. The non-transitory computer-readable medium of claim 14, wherein the one or more instructions, when executed by the one or more processors, further cause the device to:
transmit, to the generative system, a content request for the alternate version; and
receive the alternate version from the generative system in response to the content request.

20. The non-transitory computer-readable medium of claim 14, wherein the request is to cause the generative system to generate the plurality of alternate versions of the content using a generative pre-trained transformer.
